(19) United States
(12) Patent Application Publication
(10) Pub. No.: US 2024/0295736 A1
(43) Pub. Date: Sep. 5, 2024

(54) WEARABLE DISPLAY USING CIRCULARLY POLARIZED LIGHT

(71) Applicant: Moon Key LEE, Seoul (KR)

(72) Inventor: Moon Key LEE, Seoul (KR)

(21) Appl. No.: 18/573,916

(22) PCT Filed: Jun. 27, 2022
(86) PCT No.: PCT/KR2022/009163

§ 371 Date: Dec. 22, 2023

(30) Foreign Application Priority Data
Jun. 30, 2021 (KR) 10-2021-0086162
Jul. 27, 2021 (KR) 10-2021-0098861
Jan. 26, 2022 (KR) 10-2022-0011869

(51) Int. Cl. G02B 27/01; G02B 5/10; G02B 5/26; G02B 5/30; G02B 27/00

(52) U.S. Cl. CPC G02B 27/0172; G02B 5/10; G02B 5/26; G02B 5/30; G02B 27/0093

(57) ABSTRACT

The present disclosure relates to a wearable display that is transparent and has a small volume and a wide viewing angle, the display including a circular polarization maintaining and reflecting device configured to pass specific circular polarization light and reflect other circular polarization light while maintaining circular polarization light and a circular polarization inverting and reflecting device configured to reflect the light from the display and passing through the circular polarization maintaining and reflecting device back to the circular polarization maintaining and reflecting device and invert a circular polarization rotation direction in the reflecting process, wherein light rays are reflected twice by using a reflective circular polarization film so that a concave half mirror has a large radius of curvature.

### TECHNICAL FIELD

The present disclosure relates to a wearable display with a wide viewing angle.

### BACKGROUND ART

The present disclosure relates to a technology about wearable displays capable of outputting an augmented reality image or a virtual reality image.

### DISCLOSURE TECHNICAL PROBLEM

The present disclosure is directed to solve a problem in which a lens portion of a device according to Korean Patent Registration No. 10-2044628 (Transparent Glasses Type Display using Mirror), which is a prior invention by the present inventor, has a large volume.

### TECHNICAL SOLUTION

In order to solve the problem described above, the present disclosure provides a wearable display in which a reflective circular polarization film is added between a semi-transparent display and a concave half mirror and light emitted from the semi-transparent display toward the concave half mirror reciprocates twice between the concave half mirror and the reflective circular polarization film and then reaches an eye. Thus, the curvature radius of the concave half mirror is increased and the distance between the concave half mirror and the reflective circular polarization film is reduced, thereby being possible to reduce the volume of a device.

### ADVANTAGEOUS EFFECTS

While a semi-transparent display according to the present disclosure is substituted with a transparent or opaque display, the transparent or opaque display may be installed under an eye. In this case, a device according to the present disclosure may be manufactured inexpensively by using a transparent or opaque display that is easy to manufacture, instead of a semi-transparent display that is difficult to manufacture.

### DESCRIPTION OF THE DRAWINGS

FIG. 1 is a configuration diagram of the related art.

FIG. 2 is a configuration diagram according to Embodiment 1.

FIG. 3 is a diagram showing a modified example according to Embodiment 1.

FIG. 4 is a diagram showing a modified example according to Embodiment 1.

FIG. 5 is a diagram showing a modified example according to Embodiment 1.

FIG. 6 is a diagram showing a modified example according to Embodiment 1.

FIG. 7 is a configuration diagram of Embodiment 2.

FIG. 8 is a configuration diagram according to Embodiment 3.

FIG. 9 is a configuration diagram according to Embodiment 4.

FIG. 10 illustrates a prism sheet.

FIG. 11 illustrates a modified prism sheet.

FIG. 12 is a detailed view of a modified prism sheet.

FIG. 13 is a configuration diagram according to Embodiment 5

### MODE FOR INVENTION

### Embodiment 1

The present disclosure is directed to solve a problem in which a lens portion of a device according to Korean Patent Registration No. 10-2044628 (Transparent Glasses Type Display using Mirror), which is a prior invention by the present inventor, has a large volume.

Claim 6 of Korean Patent Registration No. 10-2044628 that is a prior invention is as follows.

A transparent glasses type display using a mirror, the display comprising:
a semi-transparent display located in front of an eye and emitting light only in a gaze direction; and
an optical module reflecting, toward the eye, the light emitted from the semi-transparent display in the gaze direction,
wherein each pixel of the semi-transparent display emits light of one color of three primary colors, and an eye-side surface of the pixel comprises
dichroic reflective coating that reflects the light of one color of three primary colors toward the optical module or
color absorbent coating that absorbs the light of one color of three primary colors.

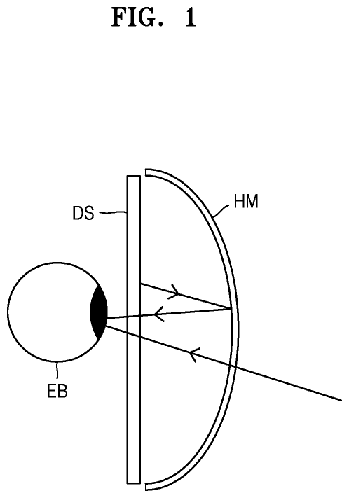

The device of the above claim may be illustrated as in FIG. 1.

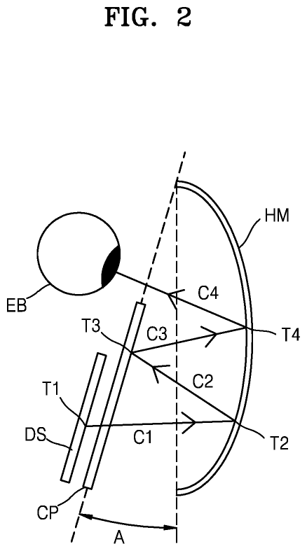

Light emitted from a semi-transparent display DS is reflected from a concave half mirror HM and then reaches an eye EB. The device has a problem that the concave half mirror protrudes convexly. In other words, the concave half mirror HM protrudes much more convexly than existing glasses lenses, making it unsightly and taking up a lot of volume. To solve such a problem, the device according to the present disclosure provides a device configured as shown in FIG. 2.

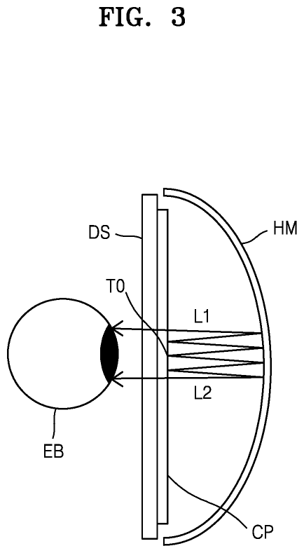

In FIG. 2, a display DS is installed in front of or around an eye. When the display DS is a semi-transparent display, the display DS may be installed in front of an eye as shown in FIG. 3. The semi-transparent display is a transparent display that emits light in a gaze direction and blocks light to an eye side, which is described in detail in the specification of the invention described above (Registration No. 10-2044628).

When the display DS is a general transparent or opaque display, as shown in FIG. 2, the display DS may be installed around an eye (e.g., below; above, or at the side of the eye). A reflective circular polarization film (CP, which is referred to as a circular polarization maintaining and reflecting device in the present disclosure) is installed in front of the display and the eye. A concave half mirror (HM, which is referred to as a circular polarization inverting and reflecting device in the present disclosure) is installed in front of the reflective circular polarization film CP. The circular polarization maintaining and reflecting device means a device that reflects incident light while maintaining circular polarization of the incident light. The circular polarization maintaining and reflecting device may be configured by attaching a ¼ wavelength phase delay film to reflective linear polarization film. Furthermore, the circular polarization maintaining and reflecting device may be configured by a reflective cholesteric liquid crystal film.

The circular polarization inverting and reflecting device means a device that reflects incident light of circular polarization by changing a rotation direction of the circular polarization of the incident light. The circular polarization inverting and reflecting device may include a mirror, a half mirror, a reflective hologram, a dichroic mirror, and the like. In the present disclosure, the mirror may be in the form of a film or filter.

As shown in FIG. 2, when the display is installed around the eye (below), the reflective circular polarization film CP may be installed in front of the display only, not in front of the eye. As shown in FIG. 3, when the display is installed in front of the eye, the reflective circular polarization film CP may be installed directly in front of the display (i.e., in front of the eye).

As shown in FIG. 2, when light is emitted from a point T1 of the display DS toward the concave half mirror HM, among the light, only first circularly polarized light C1 (e.g., right-handed circular polarization) passes through the reflective circular polarization film to proceed toward the concave half mirror HM. The first circularly polarized light C1 is reflected from a point T2 of the concave half mirror while changing a circular polarization rotation direction, and becomes second circularly polarized light C2 (e.g., left-handed circular polarization). The second circularly polarized light C2 is reflected from a point T3 of the reflective circularly polarized light CP. In this state, the rotation direction of circular polarization is maintained. Second circularly polarized light C3 reflected from the point T3 is reflected from a point T4 of the concave half mirror while changing the circular polarization rotation direction, and becomes first circularly polarized light C4. The first circularly polarized light C4 passes through the reflective circular polarization film CP and reaches the eye.

As such, the light emitted from the display reciprocates twice between the reflective circular polarization film CP and the concave half mirror HM, and thus, the curvature radius of the concave half mirror may be increased.

The concave half mirror reflects some and passes other some of light rays of all wavelengths, and thus, a large amount of light loss occurs in the process of reflecting the light from the display twice. In other words, as the amount of light from the display reaching the eye is relatively small, an image may appear dark. Such a problem may be solved by replacing the concave half mirror with a transparent curved surface (a dichroic mirror or film) with dichroic reflective coating to selectively entirely or almost entirely reflect a specific wavelength only of the light emitted from the display. For example, a concave curved surface with dichroic reflective coating to reflect light of a specific wavelength of the three primary colors emitted from the display and pass light of the other wavelength is used.

The concave half mirror HM has a radius of curvature enough to allow light rays L1 and L2 emitted from any one point T0 of a display to be reflected twice and the light rays to be in an almost parallel state at a point where the reflected light rays reach the eye, as shown in FIG. 3, so as to be easily focused on the eye of a human.

Instead of the concave half mirror, a reflective surface may be configured using a reflective hologram capable of converging light like a concave mirror. In this case, the reflective surface may not be concave.

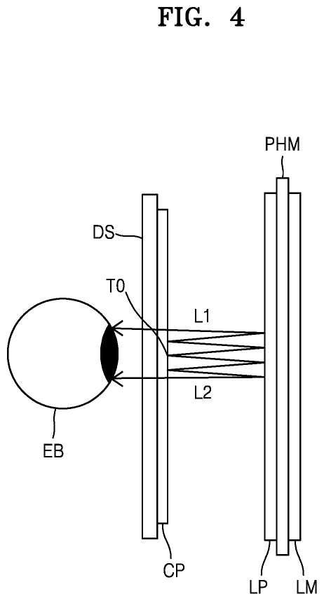

Instead of the concave half mirror, a flat half mirror or flat dichroic mirror PHM may be used. In this case, as shown in FIG. 4, a convex lens LP may be added to a surface of the flat half mirror or flat dichroic mirror PHM facing the eye BE and a concave lens LM to an opposite surface. In this case, the absolute values of focal lengths of the added convex lens and concave lens may be selected to be identical or almost identical to each other. As such, when the absolute values of focal lengths of the two lenses are identical, the convergence and divergence functions of the two lenses are offset, and thus, one can see the external scenery through the two lenses as if the two lenses do not exist. Furthermore, it is desirable to use Fresnel lenses, meta lenses, diffraction lenses, hologram lenses, and the like, as the lenses, for taking less volumes. These lenses are referred to as a convergence device in the present disclosure. The convergence device may be configured to be integrally with the circular polarization inverting and reflecting device or included in the circular polarization inverting and reflecting device.

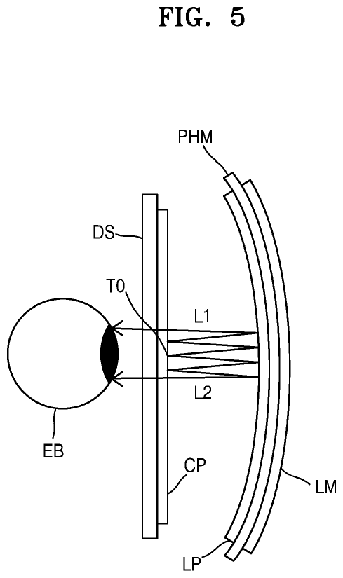

As shown in FIG. 5, a dichroic mirror PHM may be concave toward an eye, and likewise, a convex lens LP and a concave lens LM which are concave toward the eye side may be attached to both surfaces of the dichroic mirror PHM.

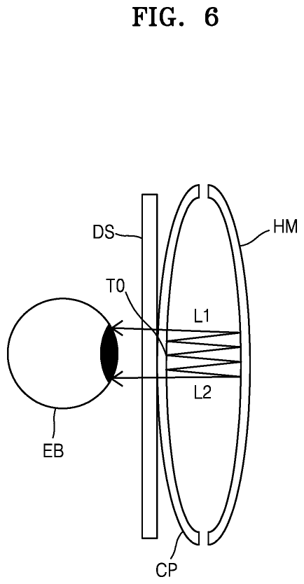

The reflective circular polarization film CP may be a curved surface that is convex toward the eye side as shown in FIG. 6. As such, when the reflective circular polarization film CP is a curved surface, the curvature radius of the concave half mirror HM may be further increased (i.e., to be more flat) so that the volume occupied by the device may be further reduced.

### Embodiment 2

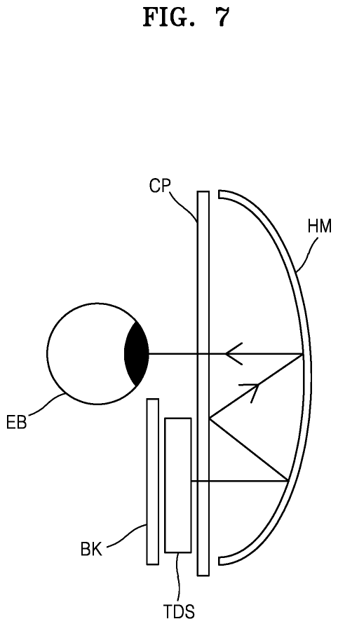

In the device of FIG. 2, the display DS may be configured by a transparent display TDS as shown in FIG. 7. Using a transparent display like this has an advantage of not blocking the front view when no image is being output because the display is transparent. However, there is a problem that, when an image is output to the transparent display, light emitted from a back surface (a surface facing the eye) of the transparent display toward the eye side reaches the eye, which makes the eye bedazzled. To prevent the dazzle, a light blocking device BK may be installed between the transparent display and the eye. The light blocking device may be largely classified into, for example, a reflective type and an absorbent type. The reflective type may be a dichroic mirror (or filter) for reflecting light of a light of a specific wavelength and passing light of the other wavelengths, and the absorbent type may be a color filter for passing light of a specific wavelength and absorbing light of the other wavelengths. Furthermore, the absorbent type may include a liquid crystal shutter and the like.

A dichroic mirror (a dichroic mirror, a dichroic filter, and dichroic coating are used with the same meaning in the present disclosure) to be used as the light blocking devicemay be a mirror or film that selectively reflects only light of a specific wavelength emitted from the transparent display and passes light of the other wavelengths. For example, when the transparent display emits light of three primary colors in a narrow wavelength range, a dichroic mirror may selectively reflect only the light of three primary colors in the narrow wavelength range and pass light of the other wavelengths. In this case, as the light of external scenery include light of a wavelength in a large range, most light of external scenery may pass though the dichroic mirror and reach the eye. In other words, when the dichroic mirror is used, the dazzle of the transparent display may be prevented, and external scenery may be seen through the transparent display.

The absorbent color filter to be used as the light blocking device is a filter for selecting absorbing only light of a wavelength emitted from the transparent display and passing light of the other wavelengths.

By installing the dichroic mirror and the color filter to overlap each other, the light of display may be surely blocked.

When the light blocking device is a liquid crystal shutter, the liquid crystal shutter may block light while an image is output to the display and pass the light while no image is output to the display. The liquid crystal shutter is a technology that is known as a shutter glasses lens worn when viewing an image through a shutter glasses type three-dimensional display. When a display switches fast between a state of outputting an image and a state of not outputting an image, a shutter is fast opened and closed in synchronization with the switching so that an external object may be viewed without dazzle.

### Embodiment 3

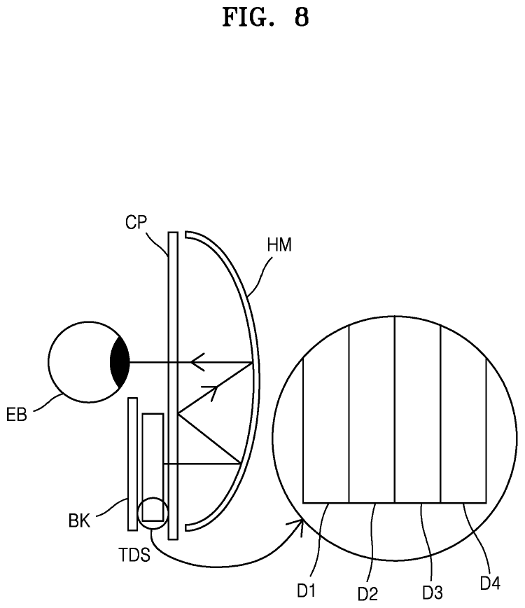

An image with depth may be output by installing the transparent display TDS of FIG. 7 as a plurality of transparent displays D1, D2, D3, and D4 as shown in FIG. 8, to overlap each other. The image with depth means an image having various distances between the eye and an image. Although FIG. 8 illustrates the four transparent displays D1, D2, D3, and D4, actually, a more or less number of transparent displays may be provided.

As such, as an image with depth may be seen by outputting an image using a multilayered transparent display, in conventional smart glasses or head mount display for virtual reality, which includes only one display, a problem of a mismatch of the convergence angle of the eye and the focal length of the eye (a vergence-accommodation conflict), may be solved.

### Embodiment 4

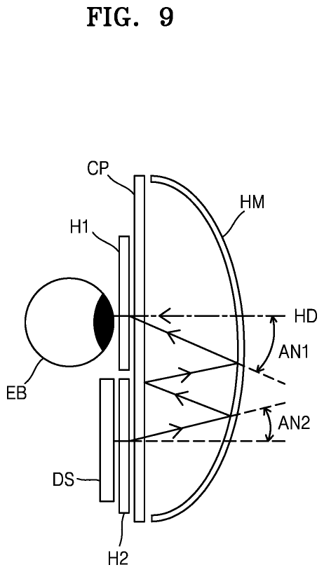

In Embodiment 1 of FIG. 2, when the display DS is an opaque display, the display may be installed below the eye below BE not to interference with the vision. In this case, in order to see a displayed image with eyes, one should lower the line of sight. To enable the display to be seen by the eyes even when the line of sight is directed to the front side, as shown in FIG. 2, an angle A between the concave half mirror HM and the reflective circular polarization film CP is increased. However, as the angle increases, it is a problem that the concave half mirror protrudes forward. The present embodiment relates to a configuration to enable the display to be seen when seeing the front side without the concave half mirror protruding forward as shown in FIG. 9.

In FIG. 9, while a first transmissive hologram H1 is installed right in front of the eye BE, a second transmissive hologram H2 is installed in front of the display DS below the eye. The second transmissive hologram H2 may be omitted. The transmissive holograms refracts light of a specific wavelength emitted from the display and passes light of the other wavelengths to proceed straight. The first transmissive hologram refracts the light emitted from the display, reflected from the concave half mirror HM, and obliquely incident to the eye side from under the eye, to be incident in a horizontal direction. The light being obliquely incident to the eye side means that an angle ANI is greater than 0 in FIG. 9. When the front side (HD, i.e., a horizontal direction) is seen through the first transmissive hologram H1, the displayed image may be seen. When the first transmissive hologram H1 does not exist, the displayed image may be seen only by lowering the line of sight so that the viewing angle of the image decrease much which is inconvenient.

The second transmissive hologram refracts the light emitted from the display in the horizontal direction upward (to the eye side). Displays usually emit the most light from the front side and less light from the sides. Thus, when there is no second transmission hologram H2, it is a problem that only a small amount of light reaches the eye so that an image becomes dark.

### Embodiment 5

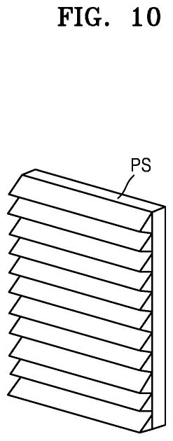

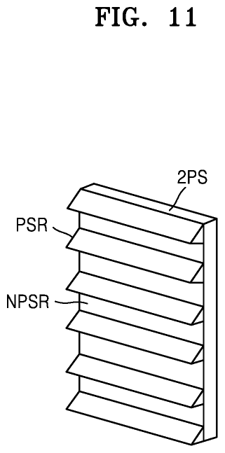

The present embodiment relates to the configuration in which the transmissive hologram of Embodiment 4 is replaced with a 2-channel prism sheet 2PS. The 2-channel prism sheet 2PS may be configured by attaching a dichroic filter or a color filter to a modified prism sheet. A prism sheet PS has a shape in which a plurality of micro primes in the form of horizontal lines are arranged in a vertical direction on a plane as shown in FIG. 10 and serves to refract incident light. The 2-channel prism sheet 2PS may be manufactured by removing (i.e., modifying) odd-numbered or even-numbered micro prisms of the prism sheet as shown in FIG. 11. The light passing through a flat area (referred to as a non-prism sheet area (NPSR)) where the micro prisms are removed passes straight forward without being refracted as if passing through a transparent glass plate. The light passing through an area (referred to as a prism sheet area (PSR)) where the micro prisms are left is refracted by the micro prisms.

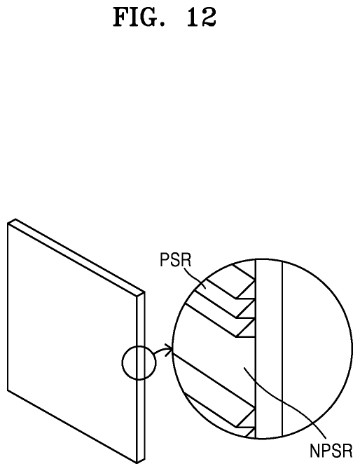

As shown in FIG. 12, more micro prisms may be included in each prism sheet area.

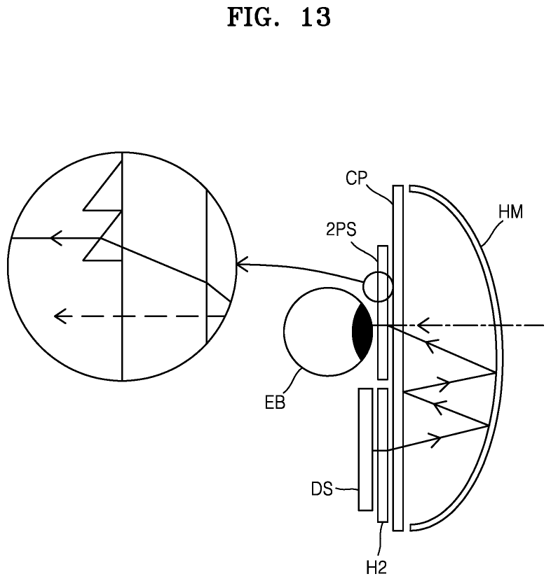

A dichroic filter for passing only the light of a specific wavelength emitted from the display and reflecting the light of the other wavelengths may be installed in the prism sheet area PSR, and reversely, a dichroic filter for reflecting only the light of a specific wavelength emitted from the display and passing the light of the other wavelengths may be installed in the non-prism sheet area. As such, when the modified prism sheet including a dichroic filter (referred to as a 2 channel prism sheet (2PS) in the present disclosure) is installed in the device of FIG. 13, instead of the first transmissive hologram H1 of FIG. 9, and the device is worn to see the front side, a displayed image and external scenery are simultaneously seen in the front. The second transmissive hologram H2 of FIG. 9 may be replaced with the 2-channel prism sheet.

Similarly, an absorbent color filter may be used instead of the dichroic filter. In other words, a color filter for passing only the light of a specific wavelength emitted from the display and absorbing the light of the other wavelengths may be installed in the prism sheet area, and reversely, a color filter for absorbing only the light of a specific wavelength emitted from the display and passing the light of the other wavelengths may be installed in the non-prism sheet area. For example, when the display emits blue light, a blue filter for passing only the blue light and absorbing light of the other wavelengths may be attached on the prism sheet area, and reversely, a yellow filter for absorbing the blue light and passing the light of the other wavelengths may be installed in the non-prism sheet area.

1. A wearable display using circularly polarized light comprising:
a display arranged in front of or around an eye and emitting light in a gaze direction:
a circular polarization maintaining and reflecting device configured to pass specific circular polarization light and reflect other circular polarization light while maintaining circular polarization light: and
a circular polarization inverting and reflecting device configured to reflect the light from the display passing through the circular polarization maintaining and reflecting device back to the circular polarization maintaining and reflecting device and invert a circular polarization rotation direction in the reflecting process.

2. The wearable display of claim 1, wherein a shape of the circular polarization inverting and reflecting device is a flat surface or a curved surface that is concave toward an eye side.

3. The wearable display of claim 1, wherein the circular polarization inverting and reflecting device comprises a mirror, a half mirror, a reflective hologram or a dichroic filter that selectively reflects only light of a specific wavelength emitted from the display.

4. The wearable display of claim 1, wherein the circular polarization maintaining and reflecting device comprises a reflective linear polarization film and a ¼ wavelength phase delay film, or a cholesteric liquid crystal film.

5. The wearable display of claim 1, wherein the circular polarization inverting and reflecting device comprises a convex lens at an eye side and a concave lens opposite the eye side, and absolute values of focal lengths of the two lenses are identical or almost identical to each other.

6. The wearable display of claim 1, wherein the display comprises an opaque display or a transparent display, which is installed around the eye, and
a light blocking device configured to selectively block only light of a specific wavelength emitted from the transparent display is arranged on a surface of the transparent display at an eye side.

7. The wearable display of claim 6, wherein the light blocking device comprises a dichroic reflective filter for reflecting light of a specific wavelength or a color filter for absorbing the light of a specific wavelength.

8. The wearable display of claim 6, wherein the transparent display comprises a plurality of transparent displays overlapping each other.

9. The wearable display of claim 1, wherein the display comprises a semi-transparent display installed in front of the eye, and
a light blocking device configured to selectively block only light of a specific wavelength emitted from the semi-transparent display is arranged on a surface of the semi-transparent display at an eye side.

10. The wearable display of claim 9, wherein the light blocking device comprises a dichroic reflective filter for reflecting light of a specific wavelength or a color filter for absorbing the light of a specific wavelength.

11. The wearable display of claim 10, wherein the light blocking device is installed at each pixel of a semi-transparent display and comprises a dichroic filter selectively reflecting light emitted from a pixel where the dichroic filter is installed or
a color filter selectively absorbing light emitted from a pixel where the color filter is installed.

12. The wearable display of claim 11, wherein each pixel emits light of one color of three primary colors, and the light blocking device comprises a dichroic filter for selectively reflecting light of one color of the three primary colors or
a color filter for selectively absorbing light of one color of the three primary colors.

13. The wearable display of claim 1, wherein the display comprises a display installed around the eye, and
a refraction device arranged in front of the eye and configured to refract light emitted from the display and obliquely incident on the eye to be incident to a front side of the eye.

14. The wearable display of claim 13, wherein the refraction device comprises a transmissive hologram configured to selectively refract only light of a specific wavelength emitted from the display.

15. The wearable display of claim 13, wherein the refraction device comprises a prism sheet area for selectively refracting only light of a specific wavelength emitted from the display and
a non-prism sheet area for passing light of other wavelengths.

16. The wearable display of claim 15, wherein the prism sheet area comprises a prism for refracting light and a dichroic reflective filter or absorbent color filter for passing only light of a specific wavelength emitted from the display, and
the non-prism sheet area comprise a dichroic reflective filter or absorbent color filter for blocking only light of a specific wavelength emitted from the display.
